(19) United States
(12) Patent Application Publication
(10) Pub. No.: US 2007/0265861 A1
(43) Pub. Date: Nov. 15, 2007

(54) High latency communication transactions in a low latency communication system

(76) Inventors: Gavriel Meir-Levi, New York, NY (US); Alexandre Bronstein, Palo Alto, CA (US)

Correspondence Address: Paul H. Horstmann, 706 Tenth Street, Hermosa Beach, CA, 90254, US

(21) Appl. No.: 11/399,971

(22) Filed: Apr. 7, 2006

(51) Int. Cl. G06Q 10/00; G06Q 30/00

(52) U.S. Cl. 705/1

(57) ABSTRACT

Techniques for communication that enable a low latency communication system to accommodate high latency communication transactions without substantial changes to its communication infrastructure. Communication according to the present teachings includes obtaining a set of information using a high latency communication transaction in response to a first attempt at a low latency communication transaction and completing a second attempt at the low latency communication transaction using the information.

### BACKGROUND

A communication system may include a set of devices that communicate via a communication network. Examples of the types of devices that may communicate via a communication network are too numerous to mention but include computer systems, retail sales terminals, appliances, instruments, display systems, information servers, service providers of various types, security systems, etc.

A communication transaction in a communication system may be a low latency communication transaction. A low latency communication transaction may be defined as a communication transaction in which a device transmits a request on a communication network and receives a response to the request via the communication network within a relatively short period of time after transmitting the request. A low latency communication transaction may be a communication transaction in which a response is generated by automated means, e.g. by a server or other automated system.

On the other hand, a communication transaction in a communication system may be a high latency communication transaction. A high latency communication transaction may be defined as a communication transaction in which a device transmits a request on a communication network and receives a response to the request via the communication network after a relatively long delay. A high latency communication transaction may be a communication transaction in which, for example, a response depends on the actions of a human being or requires communication via a network that is subject to a relatively long delays.

A communication system may be adapted to yield low latency communication transactions. One example of a communication system that is adapted to yield low latency communication transactions is a credit card authorization system that provides approval or disapproval of retail purchases. A provider of a credit card authorization system may expend large amounts of resources aimed at providing mechanisms that minimize the latency in approving credit card purchases.

A communication system that is adapted to yield low latency communication transactions may not readily accommodate high latency communication transactions. For example, a communication system that is adapted to provide low latency communication transactions may include a timeout error mechanism that limits an amount of time between a request and a corresponding response. A communication system that is adapted to provide low latency communication transactions may be modified to accommodate high latency communication transactions by making basic changes to its communication infrastructure, e.g. its timeout error mechanism. Unfortunately, such changes to a communication infrastructure may be expensive implement and may be prone to errors or may not be feasible in a communication system that is maintained by a number of different organizational entities.

### SUMMARY OF THE INVENTION

Techniques for communication are disclosed that enable a low latency communication system to accommodate high latency communication transactions without substantial changes to its communication infrastructure. Communication according to the present teachings includes obtaining a set of information using a high latency communication transaction in response to a first attempt at a low latency communication transaction and completing a second attempt at the low latency communication transaction using the information.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 illustrates a communication system that incorporates the present techniques;

FIG. 2 is a flow diagram that shows a device initiating a first attempt at a low latency communication transaction;

FIG. 3 shows a device completing a first attempt at a low latency communication transaction;

FIG. 4 shows a device completing a high latency communication transaction;

FIG. 5 shows a device initiating a second attempt at a low latency communication transaction;

FIG. 6 illustrates the handling of an authorization request associated with a low latency communication transaction.

### DETAILED DESCRIPTION

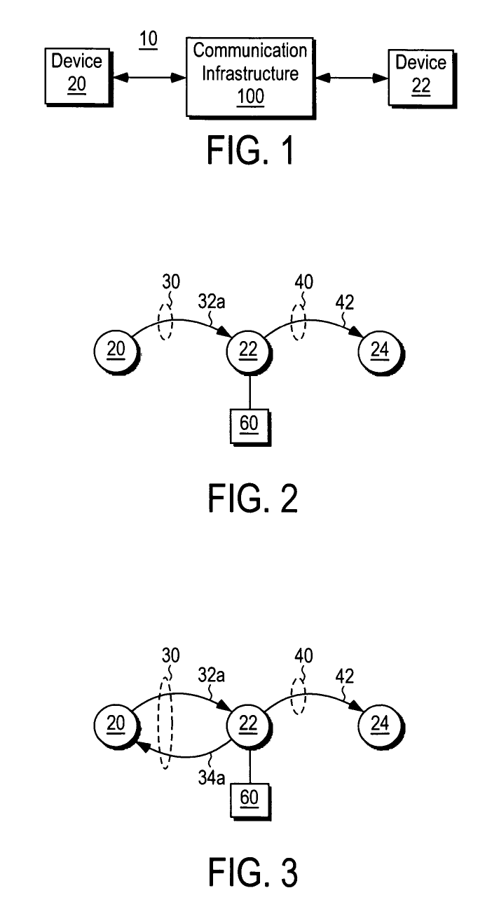

FIG. 1 illustrates a communication system 10 that incorporates the present techniques. The communication system 10 includes a pair of devices 20-22 that are adapted to perform low latency communication transactions via a communication infrastructure 100. An example of a low latency communication transaction is one in which the device 20 transmits a request to the device 22 via the communication infrastructure 100 and receives a response to that request from the device 22 via the communication infrastructure 100 such that a delay between the request and the response is relatively short.

FIG. 2 is a flow diagram that shows the device 20 initiating a first attempt at a low latency communication transaction 30 by transferring a request 32a to the device 22. The device 22 obtains a set of information from a device 24 and uses that information to construct a proper response. The device 22 obtains the information from the device 24 using a high latency communication transaction 40. The device 22 initiates the high latency communication transaction 40 by transferring a request 42 to the device 24. The device 22 may transfer the request 42 to the device 24 via the communication infrastructure 100 or via another communication channel. For example, if the communication system 10 is a credit card authorization system then the communication infrastructure 100 may be a bank computer network and the request 42 may be a telephone call to an account holder that prompts the account holder to approve/disapprove of the credit card purchase or to indicate that a fraud is underway.

The device 22 records a set of parameters associated with the request 32a in a pending transaction log 60. The parameters recorded in the pending transaction log 60 include a set of parameters that identify the request 32a and a time-stamp associated with the request 32a. The parameters recorded in the pending transaction log 60 may include parameters contained in the request 32a. For example, if the request 32a is a credit card authorization request then the parameters contained in the request 32a and recorded in the pending transaction log 60 may include a merchant identifier and a credit card number and a dollar amount.

FIG. 3 shows the device 22 completing the first attempt at the low latency communication transaction 30 before receiving a response to the request 42. The device 22 completes the first attempt at the low latency communication transaction 30 by transferring a response 34a back to the device 20. The response 34a may include an indicator that the first attempt was not completely successful. Such an indicator in the response 34a may adapted to a particular application of the communication system 10. For example, if the low latency communication transaction 30 is a credit card authorization then the response 34a may indicate “error” or “declined.”

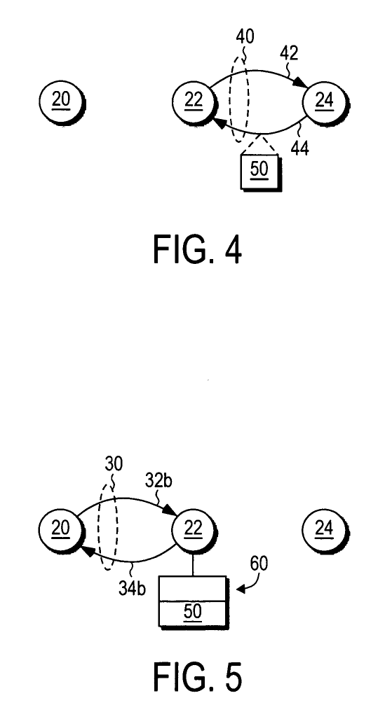

FIG. 4 shows the device 24 completing the high latency communication transaction 40 by transferring a response 44 back to the device 22. The device 24 may transfer the response 44 to the device 22 via the communication infrastructure 100 or via another communication channel. The response 44 includes a set of information 50 that enables the device 22 to construct a proper response to the low latency communication transaction 30. For example, if the low latency communication transaction 30 is a credit card authorization then the information 50 may be yes/no/fraud indicator entered by an account holder via their telephone. The device 22 stores the information 50 into the pending transaction log 60.

FIG. 5 shows the device 20 initiating a second attempt at the low latency communication transaction 30. The device 20 initiates the second attempt by transferring a request 32b to the device 22. The request 32b includes the same parameters as were contained in the request 32a, e.g. the same merchant identifier and credit card number and dollar amount. The requests 32a and 32b, are distinguishable by their timestamps.

The device 22 responds to the request 32b by transferring a response 34b back to the device 20. The device 22 uses the information 50 that was not available in the device 22 at the time of the request 32a but that is now available in the pending transaction log 60 at the time of the request 32b in constructing the response 34b. The response 34b completes the second attempt at the low latency communication transaction 30.

Other examples of the low latency communication transaction 30 and the high latency communication transaction 40 are numerous. For example, the low latency communication transaction 30 may be an issuance of a boarding pass at a boarding pass machine in an airport and the high latency communication transaction 40 may be a purchase of travel insurance for the flight. The purchase of travel insurance may be prompted by the device 22. For example, the high latency communication transaction 40 may be an automated telephone call by the device 22 to the traveler obtaining the boarding pass. The telephone call may prompt the traveler to make an entry via their telephone keypad in order to purchase travel insurance.

In another example, the low latency communication transaction 30 may be an approval of a purchase of an expensive item from a merchant and the high latency communication transaction 40 may be a purchase of property insurance for that item. In yet another example, the low latency communication transaction 30 may be an approval of a retail purchase a merchant and the high latency communication transaction 40 may be an issuance of coupons or discounts or membership bonuses from another entity, e.g. a club or other organization.

The high latency communication transaction 40 may be associated with a security measure. For example, the high latency communication transaction 40 may be an identity theft or fraud check. Similarly, the high latency communication transaction 40 may be a background check for entry onto public transportation or purchase of a firearm. The high latency communication transaction 40 may be a risk analysis that involves a risk-management algorithm, cross-data checks, purchase history profile, etc.

The following sets forth an example embodiment in which the low latency communication transaction 30 is a credit card authorization. The pending transaction log 60 includes a set of entries each for logging a transaction that is pending in the device 22 while awaiting completion of a high latency communication transaction. The contents of an entry in the pending transaction log 60 may include the following fields.

TIMESTAMP

PURCHASER_ID

TRANSACTION_PARAMETERS

STATUS

The TIMESTAMP field contains a recorded timestamp for the first attempt at the corresponding pending transaction. For example, the TIMESTAMP field of the entry in the pending transaction log 60 that corresponds to the request 32a contains the recorded timestamp for the request 32a. The timestamp for the request 32a may be generated by the device 20 and included in the request 32a or may be generated by the device 22 when it receives the request 32a.

The PURCHASER_ID field contains a recorded identifier of a purchaser associated with the corresponding pending transaction. For example, the PURCHASER_ID field of the entry in the pending transaction log 60 that corresponds to the request 32a contains a credit card number carried in the request 32a.

The TRANSACTION_PARAMETERS field contains a recorded set of parameters associated with the corresponding pending transaction. For example, the TRANSACTION_PARAMETERS field of the entry in the pending transaction log 60 that corresponds to the request 32a contains the dollar amount and seller identification carried in the request 32a.

The STATUS field contains a recorded status associated with the corresponding pending transaction. For example, the STATUS field of the entry in the pending transaction log 60 that corresponds to the request 32a contains a “first attempt” indicator before the response 44 is received from the device 24 and contains the information 50 after the response 44 is received from the device 24.

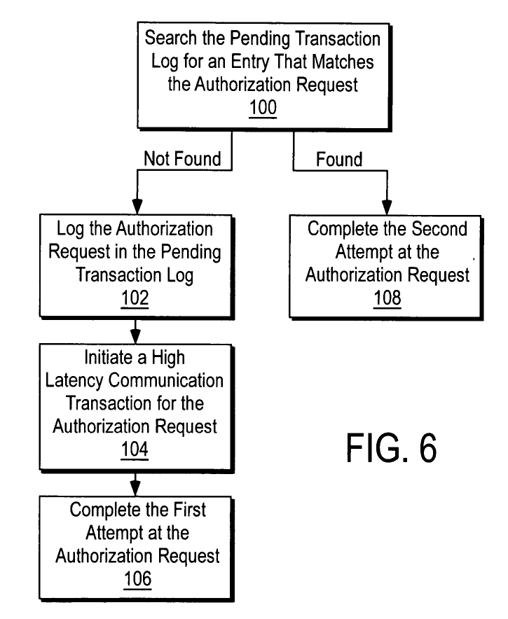

FIG. 6 illustrates the handling of an authorization request associated with a low latency communication transaction according to the present techniques. The device 22 performs the following steps in response to an authorization request from the device 20, e.g. the request 32a or the request 32b.

At step 100, the device 22 searches the pending transaction log 60 for an entry that matches the authorization request. An entry in the pending transaction log 60 matches the authorization request if its PURCHASER_ID and TRANSACTION_PARAMETERS fields match the credit card number and dollar amount and seller identification carried in the authorization request and if its TIMESTAMP field is within T0 of the timestamp associated with the authorization request. For example, T0 may be 1 minute or 2 minutes.

If a match is not found at step 100, then at step 102 the device 22 logs the authorization request. The device 22 logs the authorization request by creating a new entry in the pending transaction log 60 and recording the credit card number and dollar amount and seller identification carried in the authorization request into the PURCHASER_ID and TRANSACTION_PARAMETERS fields of the new entry and writing the TIMESTAMP field of the new entry with a timestamp for the authorization request and writing the STATUS field of the new entry with the “first attempt” indicator. At step 104, the device 22 initiates a high latency communication transaction to obtain the information needed for proper completion of the of the authorization request.

At step 106, the device 22 completes the first attempt at the authorization request by transferring a response to the requester, e.g. the device 20. The response to the requester includes an indicator that the first attempt at the authorization request has not committed. For example, the response may include an “authorization pending” indicator, a “wait” indicator, or a “try again in 1 minute” indicator.

If a match is found at step 100, then at step 108 the device 22 completes the second attempt of the authorization request by reading the information needed to properly complete the authorization request from the STATUS field of the entry found at step 100.

The second attempt at an authorization request may be prompted by the device 22. For example, the high latency communication transaction at step 104 may be a telephone call to the credit card holder who caused the authorization request by presenting their credit card to a merchant. The telephone call may request that the credit card holder approve the purchase and may also advise the credit card holder to retry the authorization, e.g. by re-swiping their credit card. A credit card authorization may be regarded a low latency and a telephone call may be regarded as high latency because a credit card authorization request/response delay is normally a few seconds whereas obtaining an input from a credit card holder via a telephone call may take up to a minute or more.

The devices 20-24 may be embodied as computer systems, retail sales terminals, appliances, instruments, display systems, information servers, service providers of various types, security systems, communication devices including telephones, handheld devices, etc. The devices 20-22 each include a communication mechanism that enables communication via the communication infrastructure 100. The devices 22 and 24 each include a communication mechanism that enables communication with one another, e.g. via the communication infrastructure 100 or via some other communication infrastructure, e.g. a telephone network.

The foregoing detailed description of the present invention is provided for the purposes of illustration and is not intended to be exhaustive or to limit the invention to the precise embodiment disclosed. Accordingly, the scope of the present invention is defined by the appended claims.

What is claimed is:

1. A method for communication, comprising:
obtaining a set of information using a high latency communication transaction in response to a first attempt at a low latency communication transaction;
completing a second attempt at the low latency communication transaction using the information.

2. The method of claim 1, further comprising recording a set of parameters associated with the first attempt when completing the first attempt.

3. The method of claim 2, wherein completing a second attempt comprises comparing a set of parameters associated with the second attempt to the parameters associated with the first attempt.

4. The method of claim 3, wherein comparing comprises comparing a timestamp associated with the first attempt to a timestamp associated with the second attempt.

5. The method of claim 1, wherein obtaining a set of information using a high latency communication transaction comprises obtaining the information via a communication infrastructure for the low latency communication transaction.

6. The method of claim 1, wherein obtaining a set of information using a high latency communication transaction comprises obtaining the information via a communication channel outside of a communication infrastructure for the low latency communication transaction.

7. The method of claim 1, wherein obtaining a set of information using a high latency communication transaction comprises obtaining the information via a telephone call.

8. The method of claim 1, wherein the low latency communication transaction comprises a credit card authorization.

9. A device that handles a low latency communication transaction by obtaining a set of information using a high latency communication transaction in response to a first attempt at the low latency communication transaction and then completing a second attempt at the low latency communication transaction using the information.

10. The device of claim 9, comprising a pending transaction log for holding a set of parameters associated with the low latency communication transaction.

11. The device of claim 10, wherein the second attempt is completed by comparing a set of parameters associated with the second attempt to the parameters associated with the first attempt.

12. The device of claim 11, wherein the parameters include a timestamp associated with the first attempt and a timestamp associated with the second attempt.

13. The device of claim 10, wherein the information obtained via the high latency communication transaction is stored in the pending transaction log.

14. The device of claim 9, wherein the information is obtained via a communication infrastructure for the low latency communication transaction.

15. The device of claim 9, wherein the information is obtained via a communication channel outside of a communication infrastructure for the low latency communication transaction.

16. The device of claim 9, wherein the high latency communication transaction comprises a telephone call.

17. The device of claim 9, wherein the low latency communication transaction comprises a credit card authorization.
